(19) United States
(12) Patent Application Publication
(10) Pub. No.: US 2024/0199856 A1
(43) Pub. Date: Jun. 20, 2024

(54) Molding Material

(71) Applicant: SEIKO EPSON CORPORATION, Tokyo (JP)

(72) Inventors: Tomohiro FUJITA, Matsumoto (JP); Shinobu YOKOKAWA, Okaya (JP); Chieko NAKAJIMA, Suwa (JP); Kiyoaki SAKAGUCHI, Suwa (JP)

(21) Appl. No.: 18/545,064

(22) Filed: Dec. 19, 2023

(30) Foreign Application Priority Data
Dec. 20, 2022 (JP) 2022-202982

(51) Int. Cl. C08L 1/02

(52) U.S. Cl. CPC C08L 1/02; C08L 2205/03; C08L 2205/16

(57) ABSTRACT

A molding material contains a polyester-based elastomer, a highly polar polyester, and cellulose fibers, a content of the polyester-based elastomer with respect to a content of the highly polar polyester is 25 percent by mass or more, and a total content of the polyester-based elastomer and the highly polar polyester is equal to or lower than a content of the cellulose fibers.

The present application is based on, and claims priority from JP Application Serial Number 2022-202982, filed Dec. 20, 2022, the disclosure of which is hereby incorporated by reference herein in its entirety.

### BACKGROUND

### 1. Technical Field

The present disclosure relates to a molding material.

### 2. Related Art

Heretofore, molding materials each containing cellulose fibers, a resin, and the like have been known. For example, JP-A-2020-33541 has disclosed a cellulose composite resin containing cellulose fibers, a main resin, such as an olefin-based resin, and a rubber-containing polymer. The rubber-containing polymer described above is formed from, for example, an aliphatic hydrocarbon or an aromatic hydrocarbon each having only a specific functional group.

However, in the cellulose composite resin disclosed in JP-A-2020-33541, when an amount of the cellulose fibers is increased, a problem in that the strength of a molded product is difficult to increase may arise in some cases. In particular, as the cellulose fibers, fibers recovered from waste paper or the like may be used. In addition, in recent years, in view of reduction in environmental load, to increase the amount of cellulose fibers in a molding material and to decrease usage of synthetic resins have been considered. As a result, since the amount of cellulose fibers is increased, an impact strength and a bending strength cannot be favorably obtained at the same time, and a molded product may be liable to be deformed or cracked in some cases. That is, a molding material capable of improving the strength of a molded product has been demanded.

### SUMMARY

According to an aspect of the present disclosure, there is provided a molding material containing a polyester-based elastomer, a highly polar polyester, and cellulose fibers, and in the molding material described above, a content of the polyester-based elastomer with respect to a content of the highly polar polyester is 25 percent by mass or more, and a total content of the polyester-based elastomer and the highly polar polyester is equal to or lower than a content of the cellulose fibers.

### BRIEF DESCRIPTION OF THE DRAWINGS

FIG. 1 is a table showing compositions and evaluation results of molding materials according to Examples.

FIG. 2 is a table showing compositions and evaluation results of molding materials according to Comparative Examples.

### DESCRIPTION OF EMBODIMENTS

### 1. Molding Material

A molding material according to this embodiment contains a polyester-based elastomer, a highly polar polyester, and cellulose fibers. To the molding material described above, a known forming method, such as injection molding or press working, may be applied. Molded products manufactured from the molding material are used as substitutes for styrene and the like and are preferably used for various types of containers; sheets; housings of office machines, such as printers; and housings of home appliances and the like. Hereinafter, various types of raw materials contained in the molding material will be described.

### 1.1. Polyester-Based Elastomer

The polyester-based elastomer has a thermoplastic property, and when a molded product is manufactured from the molding material, the polyester-based elastomer is melted to bind the cellulose fibers to each other. In addition, the polyester-based elastomer is responsible for the physical properties of the molded product together with the cellulose fibers. In particular, by the polyester-based elastomer, the toughness of the molded product is increased, and the impact strength is improved. Furthermore, in future, the polyester-based elastomer has a possibility to be produced and used as bioplastics and is expected to promote the reduction in environmental load.

The polyester-based elastomer includes, as raw material monomers, an alkyldicarboxylic acid having an alkylene group with 2 to 8 carbon atoms or a phthalic acid, and an alkylenediol having an alkylene group with 2 to 8 carbon atoms. The polyester-based elastomer is formed by copolymerization of the above two types of raw material monomers using a known synthetic method.

As the alkyldicarboxylic acid described above, for example, a linear saturated aliphatic dicarboxylic acid, such as succinic acid, glutaric acid, adipic acid, pimelic acid, suberic acid, azelaic acid, or sebacic acid, may be mentioned. Those alkyldicarboxylic acids each may have a substituent group in its molecular structure. For the synthesis of the polyester-based elastomer, at least one of those mentioned above is used.

The phthalic acid may have a substituent group in its molecular structure.

As the alkylenediol described above, for example, a divalent alcohol, such as 1,2-ethanediol, 1,3-propanediol, 1,4-butanediol, 1,5-pentanediol, 1,6-hexanediol, 1,7-heptanediol, or 1,8-octanediol may be mentioned. For the synthesis of the polyester-based elastomer, at least one of those mentioned above is used. The two types of raw material monomers described above are relatively easily available and can be used for industrial application or commercial application.

The polyester-based elastomer may also contain, besides the raw material monomers described above, another raw material monomer. As the another raw material monomer, for example, styrene, butadiene, acrylic acid, an acrylate ester, methacrylic acid, a methacrylate ester, acetonitrile, isobutylene, isoprene, or ethylene may be mentioned, and at least one of those mentioned above may be used.

When the another raw material monomer is incorporated in the polyester-based elastomer, with respect to the total number of moles of the raw material monomers, the total number of moles of the another raw material monomer is preferably set to 1% to less than 50%. Accordingly, the strength of the molded product can be further improved.

As the polyester-based elastomer, a commercial product may also be used. As the commercial product, for example, ES-A60NX, E-D27N, E-D42N, or ES Series (trade name, manufactured by ARONKASEI Co., Ltd.) may be mentioned. As the polyester-based elastomer, at least one of those mentioned above may be used.

In addition, in the molding material or in a molded body formed therefrom, the presence or absence of the polyester-based elastomer may be determined by the following physical property analysis and component analysis.

First, in the physical property analysis, the presence or absence of a component having a composite elastic modulus of 100 MPa or less is confirmed. When the component described above is contained, an elastomer component is determined to be contained. In particular, for example, using a scanning probe microscope NX20 provided by Park Systems Japan, the cross-section of the molding material or the molded body is measured in a contact mode. Accordingly, the presence or absence of the component having a composite elastic modulus of 100 MPa or less can be confirmed. In addition, the presence or absence of the elastomer component may also be confirmed using a known nanointender.

Next, by a qualitative analysis using both a pyrolysis gas chromatographic mass analysis (GC-MS) method and a Fourier transform infrared spectroscopic (FT-IR) method, whether the elastomer component is a polyester-based elastomer or not is determined. The pyrolysis GC-MS method is an analytical method to identity various types of fragments generated by pyrolysis of a test sample. The FT-IR method is an analytical method to identify the molecular structure of a test sample from an infrared absorption spectrum thereof. By those analytical methods described above, the molecular structure of the test sample can be identified.

For the pyrolysis GC-MS method, for example, a multi-shot pyrolyzer EGA/PY-3030D (manufactured by Frontier Laboratories Ltd.) and a GC/MS 5975 (manufactured by Agilent Technologies) attached thereto are used. For the FT-IR method, for example, a Nicolet (registered trademark) 380 Continupm (registered trademark) (manufactured by Thermo Fisher Scientific) is used.

### 1.2. Highly Polar Polyester

The highly polar polyester improves compatibility between the cellulose fibers and the polyester-based elastomer. Accordingly, wettability of the polyester-based elastomer to the cellulose fibers is increased, and the bending strength of the molded product is mainly improved.

The highly polar polyester has a molecular structure having a relatively high polarity, and in a repeated structure derived from a raw material monomer, the number of oxygen atoms is one or more with respect to two carbon atoms. In particular, the highly polar polyester includes, as the raw material monomer, lactic acid, hydroxybutyric acid, oxysuccinic acid, citric acid, malonic acid, succinic acid, serine, threonine, acrylic acid, methyl acrylate, or vinyl acetate. Those raw material monomers mentioned above are relatively easily available and can be used for industrial application or commercial application.

In particular, the highly polar polyester includes at least one selected from the group consisting of a poly(lactic acid), a poly(hydroxybutyric acid), a poly(acrylic acid), a poly(methyl acrylate), and a poly(vinyl acetate). Among those mentioned above, in view of reduction in environmental load, the highly polar polyester preferably includes at least one selected from the group consisting of a poly(lactic acid) and a poly(hydroxybutyric acid) each of which have biodegradability. In addition, the highly polar polyester may be a copolymer, such as a poly(ethylene-succinic acid) or P3HBH (3-hydroxy(butyrate-co-hexanoate)). As the highly polar polyester, a commercial product may also be used.

In addition, in the molding material, a content of the polyester-based elastomer with respect to a content of the highly polar polyester is preferably 25 percent by mass or more and more preferably 400 percent by mass or less. Accordingly, in the molded product, the impact strength and the bending strength can be improved with a good balance.

### 1.3. Cellulose Fibers

The cellulose fibers function as a filler material in the molded product and contribute to an increase in volume of the molding material and to an improvement in physical properties, such as the strength, of the molded product.

The cellulose fibers are plant-derived and are a relatively abundant natural material. Hence, when the cellulose fibers are used, compared to the case in which synthetic fibers are used, the reduction in environmental load is promoted. The cellulose fibers also have advantages in terms of preparation of raw materials and cost thereof. In addition, among various types of fibers, the cellulose fibers have a high theoretical strength and contribute to the improvement in strength of the molded product. As the cellulose fibers, besides the use of a virgin pulp, for example, waste paper and/or waste cloth may be recycled. In addition, as the cellulose fibers, a commercial product may also be used.

Although being mainly formed from cellulose, the cellulose fibers may contain components other than the cellulose. As the components other than the cellulose, for example, a hemicellulose and/or a lignin may be mentioned. In addition, as the cellulose fibers, cellulose fibers processed by a treatment, such as bleaching, may also be used.

In order to improve the appearance of the surface of the molded product, the cellulose fibers have an average fiber length of preferably less than 500 μm and more preferably less than 50 μm. The average fiber length of the cellulose fibers can be obtained by a method in accordance with ISO 16065-2:2007.

In the molding material, a total content of the polyester-based elastomer and the highly polar polyester is equal to or lower than a content of the cellulose fibers. Accordingly, in the molded product, the function and the effect of the cellulose fibers as the filler material can be more significantly obtained.

### 1.4. Other Additives

The molding material may contain a flame retardant as an additive. A known substance may be used as the flame retardant. As the flame retardant, for example, there may be mentioned an inorganic-based flame retardant, such as an antimony compound, a metal hydroxide, a nitrogen compound, or a boron compound, or an organic-based flame retardant, such as a brominated compound or a phosphorus compound. As the flame retardant, a commercial product may also be used.

In the molding material, when a total content of the polyester-based elastomer, the highly polar polyester, and the cellulose fibers is assumed to be 100 parts by mass, a content of the flame retardant is set to 1 to 20 parts by mass. Accordingly, the flame retardancy of the molded product can be improved.

The molding material may contain other additives besides the flame retardant. As the other additives, for example, a colorant, an insect repellent, an antifungal agent, an antioxidant, an UV absorber, an aggregation inhibitor, and/or a mold-release agent may be mentioned. In addition, the molding material may also contain, besides the polyester-based elastomer and the highly polar polyester described above, at least one of other resins.

### 2. Method for Manufacturing Molding Material

A method for manufacturing a molding material will be described. For the method for manufacturing a molding material, a known method may be used. In particular, for example, the following method may be used.

First, the raw materials described above were kneaded by a single screw kneader or a twin screw kneader into strands. Subsequently, the strands are processed by a pelletizer to form a molding material in the form of pellets.

In addition, as the method for manufacturing a molding material, the following method may also be used. First, waste paper and/or a pulp material is coarsely pulverized by a shredder machine into cellulose fibers. Next, the cellulose fibers, a polyester-based elastomer, and a highly polar polyester are weighed and then kneaded with each other. Subsequently, the raw materials thus kneaded together were deposited in air to form a sheet-shaped deposit. Since containing a large amount of air and having a low density, the deposit described above is pressed by a calendar machine to remove air, so that the density of the deposit is increased. Next, after being heated in a non-contact manner using a heating furnace, the deposit is heat-pressed by a heat press machine.

In the heating furnace and the heat press machine, the heating is performed at a temperature higher by approximately 20° C. than the melting point of each of the polyester-based elastomer and the highly polar polyester. Accordingly, a sheet is formed so that the raw materials are dispersed while suppressed from being localized.

Next, the sheet is cut by a shredder machine into pieces each having a desired shape, so that a molding material in the form of pellets is formed. Although the desired shape of the molding material is not particularly limited, a cube having a length of 2 to 5 mm may be formed. The molding material is manufactured by one of the methods described above. In addition, the method for manufacturing a molding material is not limited to that described above.

According to this embodiment, the following effect can be obtained. The strength of the molded product can be improved. Since the polyester-based elastomer and the highly polar polyester are used in combination, the balance between the impact strength and the bending strength can be improved, and those strengths can be simultaneously satisfied. Hence, a molding material to improve the strength of a molded product can be provided.

### 3. Examples and Comparative Examples

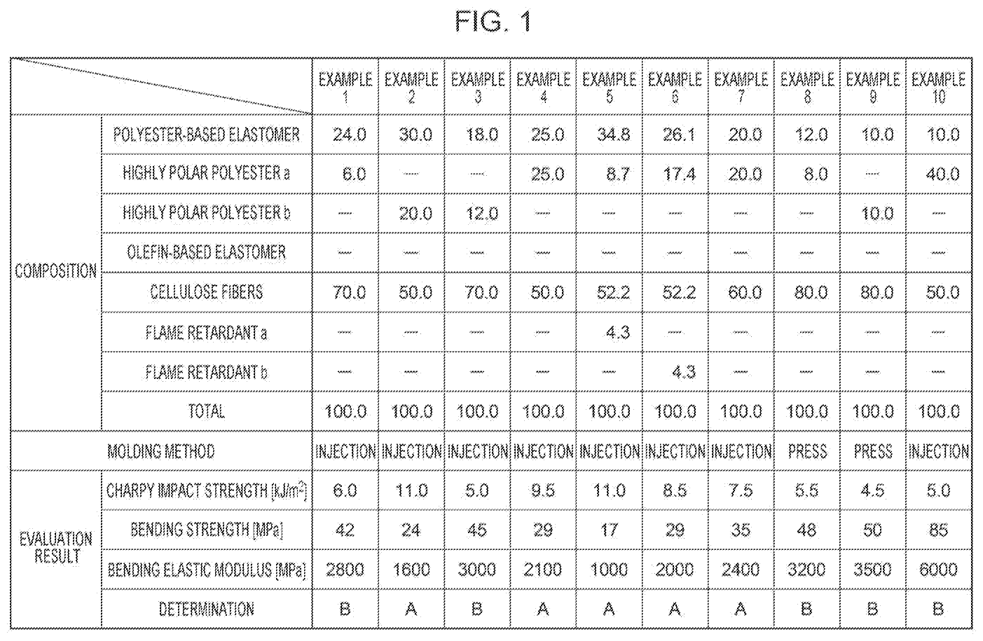

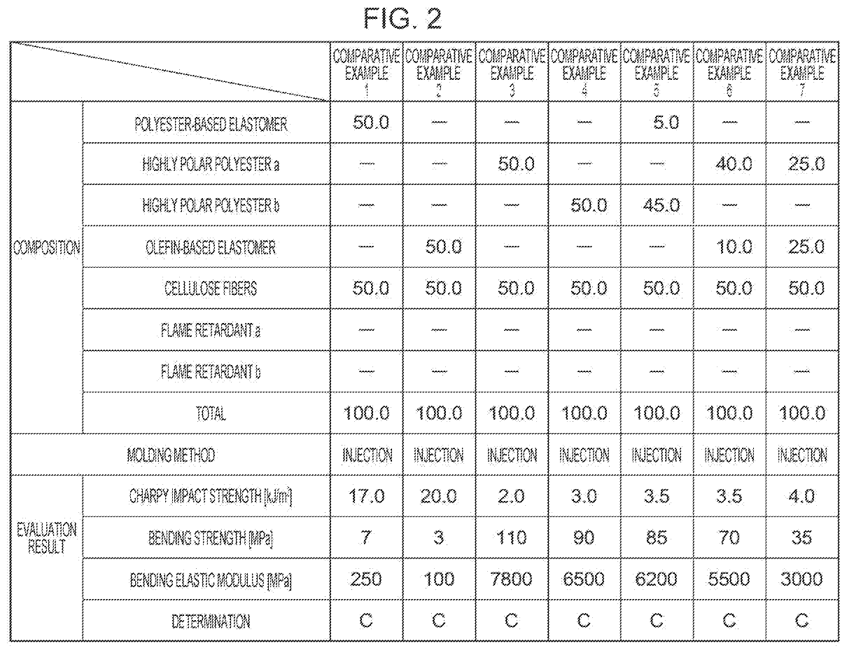

Hereinafter, by comparison between Examples and Comparative Examples, the effect of the present disclosure will be described in more detail. Compositions of raw materials of molding materials of Examples 1 to 10 and evaluation results of the molded products thereof are shown in FIG. 1. Compositions of raw materials of molding materials of Comparative Examples 1 to 7 and evaluation results of the molded products thereof are shown in FIG. 2.

In the following description, Examples 1 to 10 are also collectively simply called “Examples” in some cases, and Comparative Examples 1 to 7 are also collectively simply called “Comparative Examples” in some cases. The present disclosure is not limited at all to the following Examples. In addition, in the columns of the compositions of FIGS. 1 and 2, the unit of numerical value is percent by mass, and the column in which no numerical value is shown but “-” is shown indicates that no compound is contained. The details of the raw materials shown in FIGS. 1 and 2 are as described below.
polyester-based elastomer: trade name ES-A60Nx, manufactured by ARONKASEI Co., Ltd.
highly polar polyester a: poly(lactic acid), trade name Terramac (registered trademark) TE-2000, manufactured by Unitika Ltd.
highly polar polyester b: P3HBH, trade name Green Planet (registered trademark), manufactured by Kaneka Corporation
cellulose fibers: trade name Guaiba BEKP, manufactured by CMPC
olefin-based elastomer: EPDM (ethylene propylene diene rubber), trade name NOLDEL (registered trademark) 3720P, manufactured by Dow Toray Co., Ltd.
flame retardant a: phosphazene-based flame retardant, trade name Rabitle (registered trademark) FP-110, manufactured by Mitsui Fine Chemicals, Inc.
flame retardant b: phosphate-based flame retardant, trade name Exolit (registered trademark) OP1230, manufactured by Clariant

In accordance with the compositions shown in FIGS. 1 and 2, the molding materials of Examples and Comparative Examples were manufactured. In particular, for example, the polyester-based elastomers, the highly polar polyesters, the olefin-based elastomers as other elastomers, and the cellulose fibers were weighed.

Next, the materials described above were charged in a twin-screw kneader KZW15TW-45MG (manufactured by Technovel Corporation) and were then kneaded thereby. As the kneading conditions, a maximum heating temperature was set to 180° C., and an extrusion amount was set to 1 kg/hr. Next, after the materials described above were formed into strands, a molding material in the form of pellets was obtained using a pelletizer.

The molding materials of Examples and Comparative Examples were formed into evaluation test pieces by injection molding or press working. In particular, in the injection molding and the press working, a heating temperature of the molding material was set to 200° C. As an injection molding machine, a THX40-5V machine (manufactured by Nissei Plastic Industrial Co., Ltd.) was used, and as a press working machine, an oil hydraulic press PHKS-40ABS (manufactured by Towa Seiki Co., Ltd.) was used. The shapes of the respective evaluation test pieces will be described later.

In Example 1, the contents of the polyester-based elastomer, the highly polar polyester a, and the cellulose fibers were set to 24.0 percent by mass, 6.0 percent by mass, and 70.0 percent by mass, respectively, and the test pieces were formed by injection molding. In Example 1, the content of the polyester-based elastomer with respect to the content of the highly polar polyester a is 400 percent by mass.

In Example 2, the contents of the polyester-based elastomer, the highly polar polyester b, and the cellulose fibers were set to 30.0 percent by mass, 20.0 percent by mass, and 50.0 percent by mass, respectively, and the test pieces were formed by injection molding.

In Example 3, compared to Example 2, the contents of the polyester-based elastomer and the highly polar polyester b were decreased, and the content of the cellulose fibers was increased to 70.0 percent by mass.

In Example 4, compared to Example 1, the content of the polyester-based elastomer was slightly increased, the content of the highly polar polyester a was increased, and the content of the cellulose fibers was decreased to 50.0 percent by mass.

In Example 5, compared to Example 4, the content of the polyester-based elastomer was increased, the content of the highly polar polyester a was decreased, the content of the cellulose fibers was slightly increased to 52.2 percent by mass, and 4.3 percent by mass of the flame retardant a was added.

In Example 6, compared to Example 5, the content of the polyester-based elastomer was decreased, the content of the highly polar polyester a was increased, and the flame retardant a was replaced by the flame retardant b.

In Example 7, compared to Example 4, the contents of the polyester-based elastomer and the highly polar polyester a were decreased, and the content of the cellulose fibers was increased to 60.0 percent by mass.

In Example 8, compared to Example 4, the contents of the polyester-based elastomer and the highly polar polyester a were decreased, the content of the cellulose fibers was increased to 80.0 percent by mass, and the test pieces were formed by press working.

In Example 9, compared to Example 3, the contents of the polyester-based elastomer and the highly polar polyester b were decreased, the content of the cellulose fibers was increased to 80.0 percent by mass, and the test pieces were formed by press working.

In Example 10, compared to Example 4, the content of the polyester-based elastomer was decreased, and the content of the highly polar polyester a was increased. In Example 10, the content of the polyester-based elastomer with respect to the content of the highly polar polyester a was 25 percent by mass.

In Comparative Example 1, the content of the polyester-based elastomer was set to 50.0 percent by mass, the highly polar polyester was not used, the content of the cellulose fibers was set to 50 percent by mass, and the test pieces were formed by injection molding.

In Comparative Example 2, compared to Comparative Example 1, the polyester-based elastomer was replaced by the olefin-based elastomer.

In Comparative Example 3, the polyester-based elastomer was not used, the content of the highly polar polyester a was set to 50.0 percent by mass, the content of the cellulose fibers was set to 50.0 percent by mass, and the test pieces were formed by injection molding.

In Comparative Example 4, compared to Comparative Example 3, the highly polar polyester a was replaced by the highly polar polyester b.

In Comparative Example 5, the contents of the polyester-based elastomer, the highly polar polyester b, and the cellulose fibers were set to 5.0 percent by mass, 45.0 percent by mass, and 50.0 percent by mass, respectively, and the test pieces were formed by injection molding. In Comparative Example 5, the content of the polyester-based elastomer with respect to the content of the highly polar polyester b was less than 25 percent by mass.

In Comparative Example 6, the contents of the highly polar polyester a, the olefin-based elastomer, and the cellulose fibers were set to 40.0 percent by mass, 10.0 percent by mass, and 50.0 percent by mass, respectively, and the test pieces were formed by injection molding.

In Comparative Example 7, compared to Comparative Example 6, the content of the highly polar polyester a was decreased, and the content of the olefin-based elastomer was increased.

As an index of the impact strength, a Charpy impact strength was used, and a test method therefor was performed in accordance with ISO 179 (JIS K7111). The shape of the test piece was a rectangular plate having a long side length of 80 mm±2 mm, a short side length of 4.0 mm±0.2 mm, and a thickness of 10.0 mm±0.2 mm. As a test machine, an Impact Tester IT (manufactured by Toyo Seiki Seisaku-sho, Ltd.) was used. In a Charpy impact test, a hammer weight, a lifting angle, a width excluding notch depth, and a notch angle were set to 4J (WR2.14 N/m), 150°, 8.0 mm±0.2 mm, and 45°, respectively.

As an index of the bending strength, bending characteristics were used, and a test method therefor was performed in accordance with ISO 178 (JIS K7171). The shape of the test piece was a rectangular plate having a long side length of 80 mm±2 mm, a short side length of 10.0 mm±0.2 mm, and a thickness of 4.0 mm±0.2 mm. As a test machine, a 68TM-30 apparatus (manufactured by Instron) was used, and the test was performed with a span distance of 64 mm.

From the test results of the respective Examples thus obtained, the strength of the molded product was evaluated in accordance with the following evaluation criteria.
A: Charpy impact strength is 7.0 kJ/m² or more, and bending elastic modulus is 1,000 MPa or more.
B: Charpy impact strength is 4.5 to less than 7.0 kJ/m², and bending elastic modulus is 1,000 MPa or more.
C: Charpy impact strength is less than 4.5 kJ/m², or bending elastic modulus is less than 1,000 MPa.

As shown in FIG. 1, the evaluation results of Examples are all ranked as B or higher, and in particular, in Examples 2, 4, and 7, the evaluation results are all ranked as A. From those results described above, in Examples, it was found that the impact strength and the bending strength are both increased, and the strength of the molded product is improved.

On the other hand, as shown in FIG. 2, the evaluation results of Comparative Examples are all ranked as C, and it was found that the impact strength and the bending strength are difficult to be simultaneously satisfied.

What is claimed is:

1. A molding material containing:
a polyester-based elastomer;
a highly polar polyester; and
cellulose fibers;
wherein a content of the polyester-based elastomer with respect to a content of the highly polar polyester is 25 percent by mass or more, and
a total content of the polyester-based elastomer and the highly polar polyester is equal to or lower than a content of the cellulose fibers.

2. The molding material according to claim 1,
wherein the content of the polyester-based elastomer with respect to the content of the highly polar polyester is 400 percent by mass or less.

3. The molding material according to claim 2,
wherein the polyester-based elastomer includes, as raw material monomers, an alkyldicarboxylic acid having an alkylene group with 2 to 8 carbon atoms or a phthalic acid, and an alkylenediol having an alkylene group with 2 to 8 carbon atoms.

4. The molding material according to claim 3,
wherein the polyester-based elastomer includes, besides the raw material monomers, another raw material monomer, and
the another raw material includes at least one selected from the group consisting of styrene, butadiene, acrylic acid, an acrylate ester, methacrylic acid, a methacrylate ester, acetonitrile, isobutylene, isoprene, and ethylene.

5. The molding material according to claim 3,
wherein the highly polar polyester has a repeated structure derived from a raw material monomer, and
in the repeated structure, with respect to two carbon atoms, the number of oxygen atoms is one or more.

6. The molding material according to claim 5,
wherein the highly polar polyester includes at least one selected from the group consisting of a poly(lactic acid) and a poly(hydroxybutyric acid).

7. The molding material according to claim 1,
wherein the cellulose fibers have an average fiber length of less than 500 μm.
